(19) United States
(12) Patent Application Publication
(10) Pub. No.: US 2017/0316352 A1
(43) Pub. Date: Nov. 2, 2017

(54) Interactive Dining Table

(71) Applicant: Nabil M Abujbara, Irvine, CA (US)

(72) Inventor: Nabil M Abujbara, Irvine, CA (US)

(21) Appl. No.: 15/654,678

(22) Filed: Jul. 19, 2017

Related U.S. Application Data
(63) Continuation of application No. 13/415,838, filed on Mar. 8, 2012.
(60) Provisional application No. 61/450,556, filed on Mar. 8, 2011.

(51) Int. Cl. G06Q 10/06; G06Q 50/22; G06Q 50/12

(52) U.S. Cl. CPC G06Q 10/06; G06Q 50/12; G06Q 50/22

(57) ABSTRACT

Dining table with embedded interactive displays capable of detecting the presence of personal identification card carried by a food serving establishment guest and displaying on the closest proximity interactive display to the guest a personalized set of menu items and recommended portion sizes out of the larger set of available food menu items listed on the menus of food serving establishments; the presented personalized subset of food items and portion sizes are selected based on one or more of a multitude of criteria identified by looking up the personal record of the guest utilizing the personal identification information stored in the guest's personal identification card.

### CROSS REFERENCE TO RELATED APPLICATION

This application is a Continuation application of U.S. Non-Provisional application Ser. No. 13/415,838 filed on Mar. 8, 2012 and titled “Personal Menu Generator” which claims the benefit of priority of U.S. Provisional Patent Application Ser. No. 61/450,556, filed on Mar. 8, 2011, titled “Personalized Menu Generation Method and System”, now expired. The entire contents of the above applications are incorporated herein by reference.

This application claims the benefit of U.S. Provisional Patent Application Ser. No. 61/450,556, filed on Mar. 8, 2011.

### BACKGROUND OF THE INVENTION

### 1. Field of the Disclosure

The present disclosure relates generally to computer-assisted nutrition and health management systems and specifically to personalized menu generation methods and systems.

### 2. Description of the Related Art

It is known in the human nutrition and wellness fields that reaching and maintaining one's optimum weight and health goals requires a significant effort, knowledge, and discipline in consistently selecting and consuming the proper foods, performing sufficient physical activities, and managing any prescription and non-prescription medications.

It is also known that nutrient and energy needs as well as preferred and available foods differ from person to person based on many personal, health, cultural, and economic variables.

From a nutrition and wellness management point of view, individuals are advised to maintain a healthy weight by maintaining balance between the burnt and consumed amounts of energy (i.e. calories). Additionally, they are advised to consume foods that contain personalized proportions of macronutrients (i.e. percentages of calories obtained from protein, fat, and carbohydrates), and minimum amounts of essential micronutrients (i.e. vitamins, minerals, antioxidants, and phytochemicals); without exceeding the upper limits of certain vitamins and minerals which may cause toxic effects when consumed in high quantities over an extended period of time. Examples are Vitamin A, iron, and copper.

Even when people know what needs to be done from a nutritional and wellness point of view to stay healthy, it is difficult for them to consistently consume the appropriate varieties and portions of the particular food items which keep the aforementioned balance between energy and nutrient budgets. Additionally, they need to memorize the energy and nutrient contents of hundreds of types of foods they consume, keep track of their calorie and nutrient budgets, avoid negative interactions between certain foods and medications and take the appropriate dosage of certain nutritional supplements when their food intake does not supply their body's minimum daily nutrient requirements.

To assist users in resolving some of these difficulties existing solutions employ mobile communication devices, computer systems and networks to keep track of people's energy budgets and recommend healthy food items and preparation recipes. Health-conscious people utilize some of these solutions and have more control over managing a balanced diet when they prepare their own meals; since they have access to the calorie, macronutrient, and micronutrient contents and ingredients of foods they procure, prepare and consume.

However, with today's busy lifestyles, people frequently turn to food preparation and service establishments to supply some of their meals. When eating meals prepared by Food Establishments (FEs) such as restaurants and cafeterias, health conscious people who desire to keep their daily energy budgets and nutrient intake requirements under control, often face difficulties in selecting the menu items that would keep them in control of their monetary, energy and nutrient budgets.

One source of the difficulties faced by health conscious people when eating at FE's, is that FEs usually offer their guests a large number of food selections with varying ingredients having undeclared energy and nutrient contents. Presented with all these menu selections, the guest may order items which could cause his daily energy budget to be exceeded without consuming the minimum daily micronutrient requirements, leading to suboptimal short-term and long-term health effects. For example, the ordered food items may contain higher calories, higher sodium, lower fiber, lower potassium, lower magnesium, and/or lower vitamin K than what is needed by a specific guest at the time the meal is to be consumed.

In other cases, some of the offered foods may contain ingredients not desired by guests due to allergies, cultural, or religious reasons. For example: Dairy products, nuts, pork, meats, gluten, alcohol.

Additionally, the amounts of nutrient components of many items on the menus can be harmful to people taking certain medications, such as alcohol's interaction with insulin and grapefruit's interaction with Lipitor. These interactions may be permanent or temporary.

In many other cases, there may not be sufficient time for each guest to select the optimum food items to eat leading to hasty selection and consumption of less healthy or unknowingly harmful foods.

In attempts to help their guests make healthier food item selections, many restaurants are beginning to publish the energy (calories) amounts contained in each food item they offer. However, this information is not sufficient to help guests find the subset of food items that would also supply the most amount of nutrients needed by their bodies at the present time, avoid interactions with medications, or exceed certain nutrient upper limits.

Some computer-assisted personalized menu solutions assist a restaurant guest in narrowing down the restaurant's food item selections to an “acceptable” subset of menu selections by eliminating all food items from restaurant menus which are “unacceptable” to the particular guest. However, this approach eliminates menu items which may be healthy for the user if consumed in smaller portions.

Other solutions allow the user to customize the restaurant's menu items based on inputs from the user indicating dietary preferences and concerns. However, this approach relies on the person to maintain awareness of their personalized energy and nutrient balances, which are usually not static parameters and change throughout the day dependent on previous meals and the total personalized energy and nutrient budgets.

As can be seen, available menu generating solutions address some, but not all the problems facing individuals when dining at or consuming food items prepared at Food Establishments, described earlier.

In light of the above, what is needed is an automated and proactive way to present each guest with a personalized subset of customized menu items in the appropriate portions, which would meet the guest's personal diet preferences, avoid violating any cultural, health, or medical restrictions, and satisfy his nutritional (macronutrient and micronutrient) needs while staying within the monetary and individualized energy budgets and below certain nutrient upper limits.

### SUMMARY OF THE INVENTION

The present invention solves the above-mentioned problems by providing personal menu generator methods, systems, and devices that are capable of automatically generating and presenting each food establishment guest with a personalized subset of menu items and their recommended serving portions, which would contribute towards meeting the guest's individualized energy and nutrition requirements, while avoiding any negative interactions with medications, avoiding violating any cultural or medical restrictions, and staying within the individualized energy budget, macronutrient proportions, and below micronutrient upper limits.

In one embodiment of the present invention, a computer-implemented method for assisting users in managing their food choices when planning to consume food offered by food establishments comprised of accessing, by the one or more computers, user personal and health-related information which include as a minimum the current calorie and nutrient budget balances for a specific user, receiving, into the one or more computers, a list of menu items with metadata describing each menu item available at one or more food establishments, removing, by the one or more computers, all menu items from each food establishment's received menu item lists that, if consumed, will cause harm to the user based in part on the personal and health-related information, adjusting, by the one or more computers, the portions and ingredients of each remaining menu item, if needed, so that if consumed by the user, the calorie and nutrient budget balances will not be exceeded, presenting, by the one or more computers, the adjusted menu items to the user, receiving, into the one or more computers, a signal indicating the one or more menu items selected by the user for consumption, approving, by the one or more computers, the selected one or more menu items if their total cost, total energy, and total nutrient contents are within the user's current monetary and nutritional budgets, unapproving, by the one or more computers, the selected one or more menu items if their total cost, total energy, or total nutrient contents are not within the user's current monetary and nutritional budgets, approving, by the one or more computers, the previously unapproved set of selected menu items after the user makes item or portion adjustments to bring the total cost, energy, and nutrient content within the user's current monetary, energy, and nutrient budgets, obtaining, into the one or more computers, the actual portions consumed by the user, and adjusting, by the one or more computers, the remaining calorie and nutrient budget balances based on the energy and nutrient contents of the consumed portions.

The method will further limit the consumption of certain food items that contain high amounts of certain nutrients deemed to have harmful effects on the user's health and well being. In one embodiment of the present invention, personal dietary guideline information such as low-sodium and low fat can be sent to the FE 100 food preparation staff along with the guest's food order to reduce the amounts of salt and added fats during preparing this guest's meal.

In another embodiment, a personal menu generator system comprised of at least one computing platform, one or more medical and nutrition knowledge databases, one or more food nutrient databases, storage means, input means, communications means, and display means receives currently available menu items with ingredients and prices of each menu item from at least one food establishment, removes all menu items that do not meet pricing budgets, or contain harmful or undesirable ingredients, temporarily remove all menu items that may interact with user's medications taken around the time of meal consumption, adjust the portions and ingredients of each remaining menu item so that if consumed by the user, the current calorie and nutrient budget balances will not be exceeded, presents the adjusted menu items to the user, receives a signal indicating the menu items selected by the user for consumption, approve the selected one or more menu items if their total cost, total energy, and total nutrient contents are within the user's current monetary and nutritional budgets, unapproves the selected one or more menu items if their total cost, total energy, or total nutrient contents are not within the user's current monetary and nutritional budgets, approves the previously unapproved set of selected menu items after the user makes item or portion adjustments to bring the total cost, energy, and nutrient content within the user's current monetary, energy, and nutrient budgets, obtains the actual portions consumed by the user, and adjusts the remaining calorie and nutrient balances based on the energy and nutrient contents of the consumed portions.

In yet another embodiment, a computer-readable medium has computer executable instructions stored thereon, the instructions being executable by one or more computing devices in order to cause the one or more computing devices to perform operations comprising accessing user personal and health-related information, receiving a list of menu items with metadata describing each menu item from at least one food establishment, permanently removing all menu items that do not meet pricing budgets, or contain harmful or undesirable ingredients, temporarily removing all menu items that may interact with the user's medications taken or to be taken around the time of meal consumption, dynamically adjusting the portions and ingredients of each remaining menu item so that if consumed by the user, the current calorie and nutrient budget balances will not be exceeded, presenting the adjusted menu items to the user, receiving a signal indicating the one or more menu items selected by the user for consumption, approving the selected one or more menu items if their total cost, total energy, and total nutrient contents are within the user's current monetary and nutritional budgets, unapproving the selected one or more menu items if their total cost, total energy, or total nutrient contents are not within the user's current monetary and nutritional budgets, approving the previously unapproved set of selected menu items after the user makes item or portion adjustments to bring the total cost, energy, and nutrient content within the user's current monetary, energy, and nutrient budgets, obtaining the portions actually consumed by the user, and adjusting the remaining calorie and nutrient balances based on the energy and nutrient contents of the consumed portions.

In yet another embodiment, a personal mobile device capable of generating a personal subset of menu items comprised of one or more processors, User interface, communication unit, one or more computer-readable storage devices, containing a personalized food nutrition content database and personal and health-related information for a particular user configured to receive a list of menu items with metadata describing each menu item currently available at one or more food establishments, remove all menu items from each received food establishment's menu item list that, if consumed, will cause harm to the user based in part on the personal and health-related information, adjust the portions and ingredients of each remaining menu item, if needed, so that if consumed by the user, the current calorie and nutrient budget balances will not be exceeded, present the adjusted menu items to the user, receive a signal indicating the one or more menu items selected by the user for consumption, approve the selected one or more menu items if their total cost, total energy, and total nutrient contents are within the user's current monetary and nutritional budgets, unapprove the selected one or more menu items if their total cost, total energy, or total nutrient contents are not within the user's current monetary and nutritional budgets, approve the previously unapproved set of selected menu items after the user makes item or portion adjustments to bring the total cost, energy, and nutrient content within the user's current monetary, energy, and nutrient budgets, obtain the actual portions consumed by the user, and adjust the remaining calorie and nutrient budget balances based on the energy and nutrient contents of the consumed portions.

This is a brief list of the various benefits of the present invention when compared with other menu generating solutions available today:

1. Locating Food Establishments which have the most affordable and healthiest food items at the current time.

2. Automated food item and portion selection takes the burden off the user from having to remember the nutritional contents of each food, and then finding and selecting foods to consume that will satisfy his continuously changing energy and nutrient balances during the day.

3. Encouraging the user to consume the recommended food items in order to maintain balance between the energy intake and expenditure, without exceeding or lowering the recommended micronutrient intake requirements.

4. Improvement in users' long-term health outcomes by consuming healthy balanced meals, and avoiding negative interactions with medications.

5. Promoting chronic disease self-management, which minimizes the burden on the national health systems, thus leading to major healthcare cost reductions.

### BRIEF DESCRIPTION OF THE DRAWINGS

FIG. 1 is an illustration showing the major entities involved in the implementation of various embodiment of the present invention.

FIG. 2 is an illustration showing the various possible network communications paths connecting the major system components involved in implementing various embodiments of the present invention

FIG. 3 shows the major building blocks of a sample embodiment of a Personal Nutrition Management Server, PNMS, required for some embodiments of the present invention.

FIG. 4 shows typical contents of a Secure Customer Record usually stored in the PNMS.

FIG. 5 is Table 1, which shows sample entries of a Food Nutrient Content Database.

FIG. 6 shows the major building blocks of a typical Food Establishment Server, FES, required for implementing certain embodiments of the present invention.

FIG. 7 shows Sample Entries of Food Establishment Available Food Items & Nutrition Facts Database

FIG. 8 shows the major building blocks of a full-featured Personalized Mobile Device, PMD, utilized in certain embodiments of the present inventions.

FIG. 9 shows typical contents of a PMD's “Personal Preferences & Usage History Store”

FIG. 10 shows the major building blocks of a typical Personal Identification Card, PIC, utilized in certain embodiments of the present inventions.

FIG. 11 shows the major building blocks of a typical Food Establishment's Personalized Menu Presentation Device (FE PMPD) and Point of Sale Terminal (FE POST), utilized in certain embodiments of the present inventions.

FIG. 12A shows an embodiment of the present invention where the PMD interacts directly with the FES without having to interact with the PNMS.

FIG. 12B shows an embodiment of the present invention where the PMD interacts directly with the FES POST without having to interact with the FES.

FIG. 13 is a flowchart detailing the steps taken by the various components of the disclosed system shown in FIGS. 12A and 12B to construct and utilize an individualized food item menu for each user.

FIG. 14A shows the individualized food item menus constructed for 4 different guests in a Food Establishment utilizing an embodiment of the present invention.

FIG. 14B shows a sample list of a Food Establishment Available Menu Items.

FIG. 14C shows the Construction Steps of a Personalized Menu for a Vegetarian Guest.

FIG. 14D shows the Construction Steps of a Personalized Menu for a Diabetic Guest on Metformin & Lipitor.

FIG. 15 shows an embodiment of the present invention where the user's PMD relies on the services of the PNMS.

FIG. 16 is a flowchart detailing the steps taken by the various components of the disclosed system shown in FIG. 15 to construct and utilize an individualized food item menu for the user.

FIG. 17 shows an embodiment of the present invention where the user utilizes a Personal Identification Card (PIC) and relies on FE PMPD UI for display and selection of individualized menu food items.

FIG. 18 is a flowchart detailing the steps taken by the various components of the disclosed system shown in FIG. 17 to construct and utilize an individualized food item menu for the user.

### DETAILED DESCRIPTION OF CERTAIN EMBODIMENTS

The following description is of certain illustrative embodiments of the present invention, and it is understood that the disclosure is not limited to these embodiments, but includes alternatives, equivalents, and modifications such as are included within the scope of the claims.

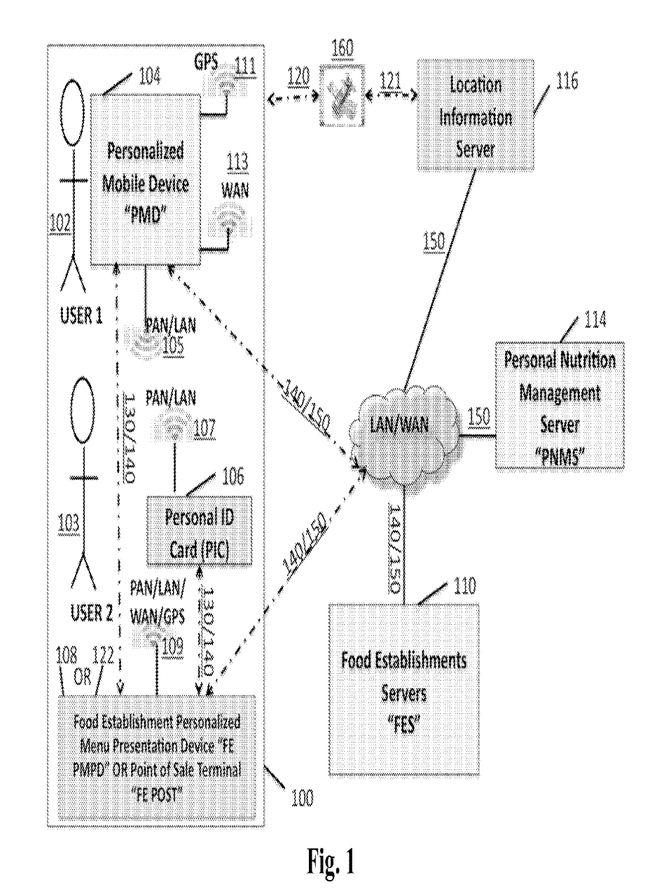

FIG. 1 is an illustration showing the major entities involved in the implementation of various embodiments of the present invention.

Food Establishment (FE) 100 can be a restaurant or cafeteria or any other food service entity where a variety of food items are typically offered to customers such as User1 102 and User2 103 via menus from which to select one or more food items they desire to consume.

Alternatively, FE 100's food item menu can be accessed virtually by users who prefer to order food remotely. This can be done via a web interface running on any of a plurality of the user's internet-connected devices; such as a mobile phone, personal computer, television, car, or any other connected device.

FE 100 may be equipped with one or more “Food Establishment Personalized Menu Presentation Devices” abbreviated as “FE PMPD” 108, to be described in more detail below.

In some embodiments of the present invention, FE 100 may also contain advanced Point of Sale Terminals, “FE POST” 122, which have similar architecture and connectivity to FE PMPD 108 devices.

“FE PMPD” 108 and “FE POST” 122 are equipped with multi-radio transceivers 109 capable of communicating with several devices and entities over Personal Area Network (PAN) 130, Local Area Network (LAN) 140, Wide Area Network (WAN) 150 and Global Positioning System (GPS) position detection satellite 160 over communication link 120.

User1 102 carries a Personalized Mobile Device (PMD) 104, which is capable of communicating with other devices, such as FE PMPD 108 and FE POST 122, over a Personal Area Network (PAN) 130, utilizing transceivers 105 and 109, respectively, and communications protocols defined by standards such as USB, Bluetooth, Zigbee, Radio Frequency Identification (RFID), or Near Field Communication (NFC).

PMD 104 may also be capable of communicating with other devices and computing entities over a Local Area Network (LAN) 140, utilizing transceiver 105 and communications protocols defined by standards such as Ethernet or Wi-Fi.

PMD 104 may also be equipped with a Global Positioning System (GPS) transceiver 111, which enables it to establish communication links with Satellite 160 over link 120, which can determine the physical location of PMD 104 and reports it to Location Information Server 116 over communication link 121 which can share the location information with other computing entities over WAN 150.

PMD 104 can also be equipped with a Wide Area Network (WAN) transceiver 113, which enables it to establish wired or wireless communication links with devices and other computing entities over WAN 150.

PMD 104 is equipped with a User Interface allowing User1 102 to interact with PMD 104 for performing the various functions described herein.

In one embodiment, User2 103 carries a Personal Identification Card (PIC) 106, which is capable of communicating to other devices, such as “FE PMPD” 108 and “FE POST” 122, over a Personal Area Network (PAN) 130, utilizing transceivers 107 and 109, respectively, and communications protocols defined by standards such as USB, Bluetooth, Zigbee, Radio Frequency Identification (RFID), or Near Field Communication (NFC).

Some implementations of PIC 106 may have the capability to communicate with “FE PMPD” 108 and “FE POST” 122 over a Local Area Network (LAN) 140, utilizing transceivers 107 and 109, respectively, and communications protocols defined by standards such as Ethernet or Wi-Fi.

PIC 106 does not typically have a User Interface and User2 103 usually depends on utilizing the User Interfaces of other devices, such as FE PMPD 108 to view and select items from the individualized food item subsets provided by various embodiments of the present invention. The operation of PIC 106 will be described in more detail below.

Additionally, PMD 104, “FE PMPD” 108, and “FE POST” 122 can be implemented to be capable of communicating over networks LAN 140 and/or WAN 150 with several entities; such as Personal Nutrition Management Server (PNMS) 114 and Food Establishment (FE) Servers, FES 110, whose functionality will be explained in detail below.

PNMS 114 and FES 110 are capable of communicating with Location Information Server 116 over WAN 150 for locating devices and establishments as needed to implement the various invention embodiments and as will be described in more detail below.

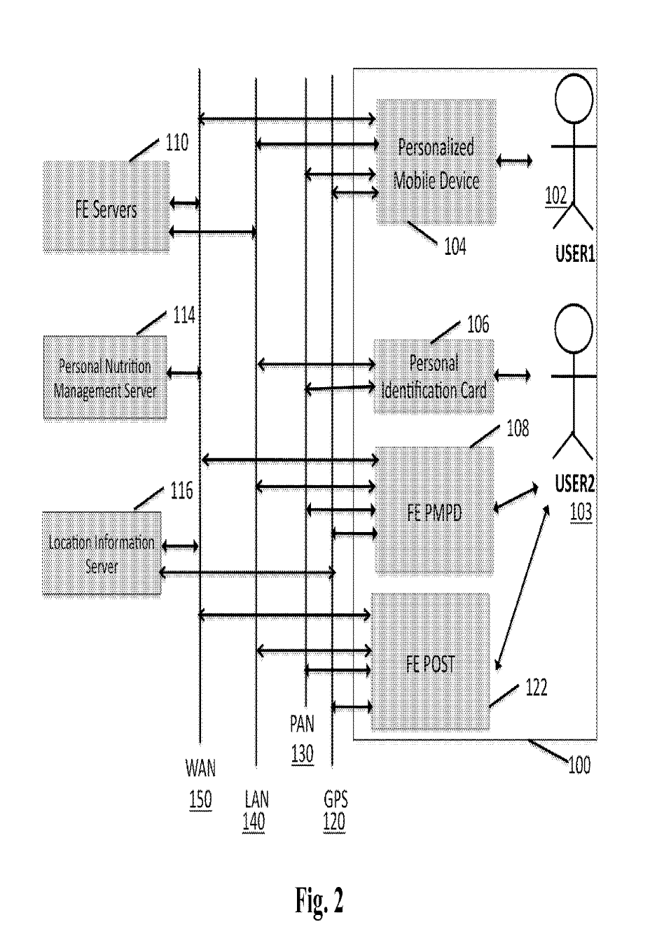

FIG. 2 is an illustration showing the possible communication paths interconnecting the major system components shown in FIG. 1 as implemented in various embodiments of the present invention.

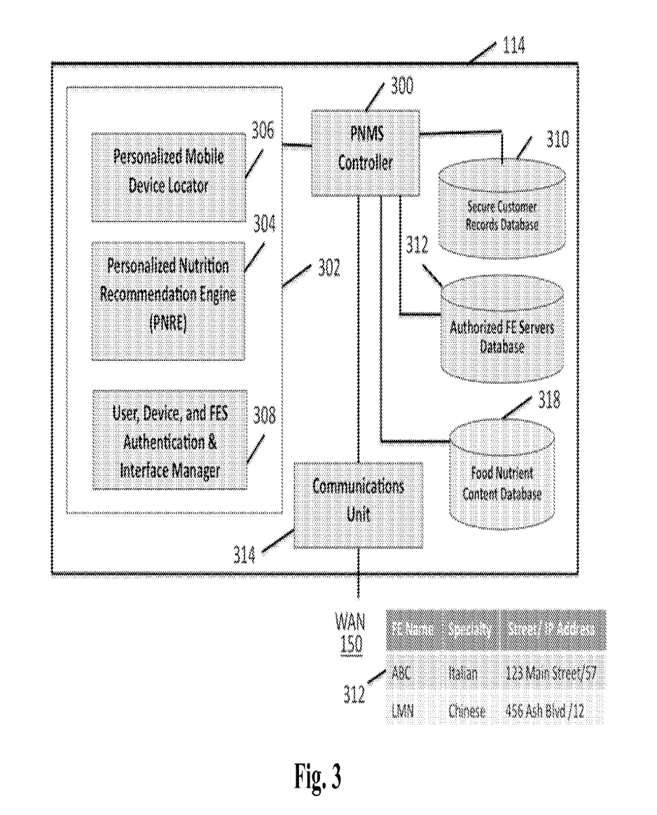

FIG. 3 shows the major building blocks of a sample embodiment of Personal Nutrition Management Server, PNMS 114; which is comprised of:

PNMS Controller 300 is responsible for executing the instructions necessary to realize the various functions 304, 306, and 308, which are described in more detail in the sections below. PNMS Controller 300 can be implemented out of cloud-based computing resources, or by using off-the-shelf or custom computer server components,

Memory subsystem 302 houses the machine readable instructions executed by PNMS Controller 300 to realize functions 304, 306, and 308, which are described in more detail in the sections below. Memory subsystem 302 can be implemented by using random access memory devices.

Communications Unit 314 enables PNMS 114 to communicate with other devices and computing entities over WAN network 150.

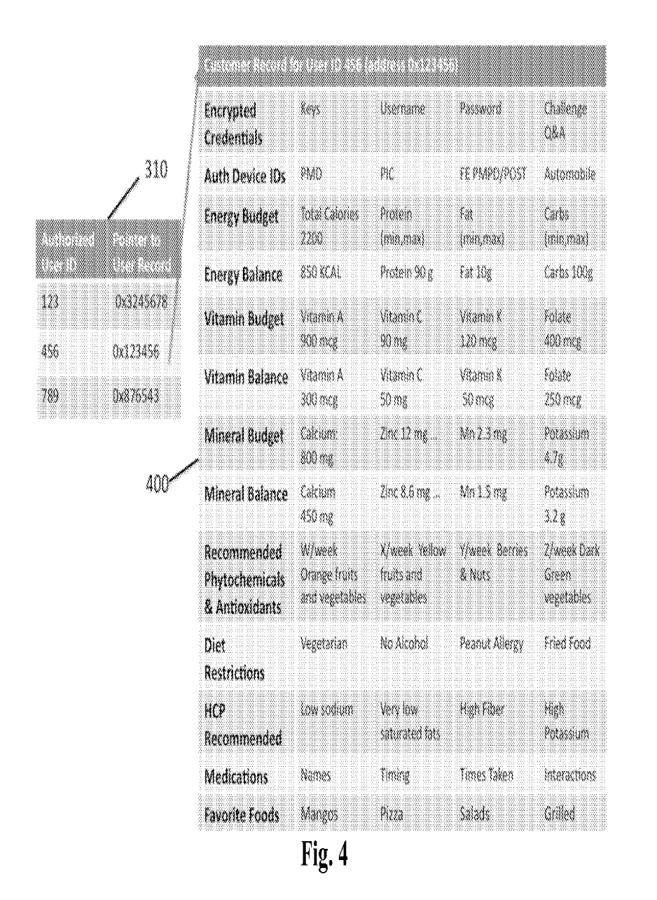

Secure Customer Records database 310 can be housed in any non-volatile storage media and contains several pieces of information about each user authorized to obtain the food item personalization services of PNMS 114. An example of an entry in database 310 showing the structure and contents of one embodiment of a secure customer record will be described in more detail below and is shown in FIG. 4.

Authorized FE Servers Database 312 can be housed in any non-volatile storage media and contains an entry for each authorized Food Establishment FE 100, which contains the FE 100 name, physical address, any food specialties, and the unique IP address pointing to the FES 110 hosting the actual list of food items currently available at each FE 100 location.

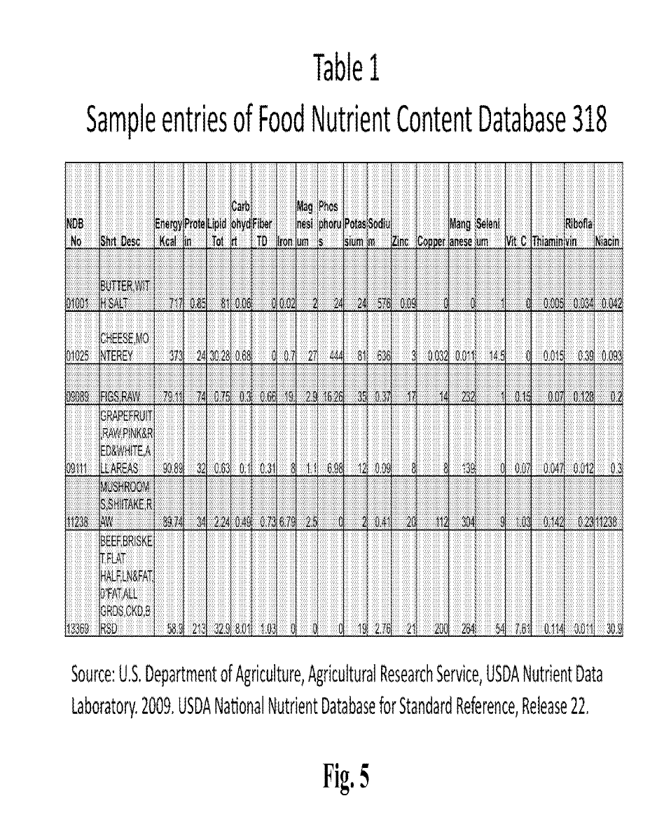

Food Nutrient Content Database 318 can be housed in any storage media and contains values of the energy, macronutrients, vitamins, and minerals contents for thousands of food items. Sample entries of a typical Food Nutrient Content Database 318 are shown in FIG. 5.

PNMS 114 is responsible for performing the following functions, which are housed in Memory subsystem 302 and executed by PNMS Controller 300:

Personalized Nutrition Recommendation Engine (PNRE) 304 is responsible for recommending a personalized ranked list, with estimated portion sizes, of the most appropriate food items for each requesting food establishment guest to select from for near-term consumption. The personalization and ranking of recommended food items and portion size estimation are based on the following information:

1. Each requesting guest's current energy and nutrient budgets and remaining balances as of this instant and other relevant attributes listed in FIG. 4. Examples of the guest's attributes are diet restrictions, remaining energy and nutrient budget balances, favorite foods, medication and nutritional supplements types and their timing, amount of money the guest is willing to spend for meals, and HCP recommended foods and nutrients. A more complete list of user attributes is shown in FIG. 4.

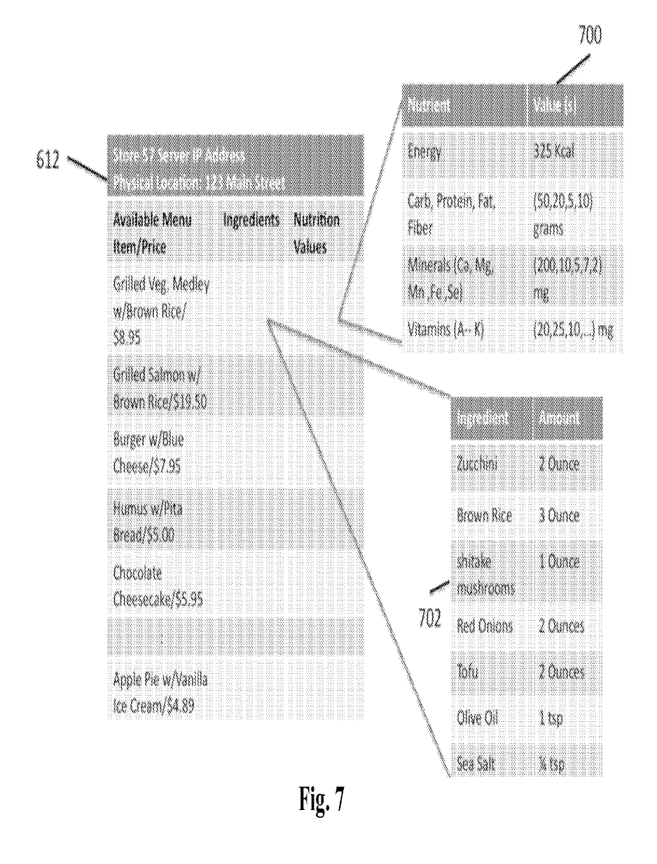

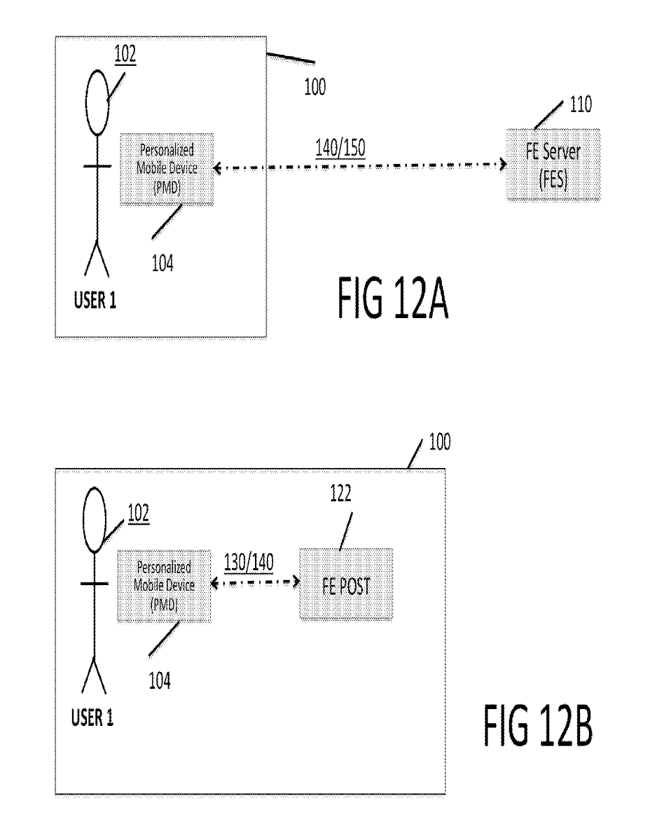

2. The Food Establishment's available food items and their attributes as shown in FIG. 7. Examples of food item attributes analyzed by PNRE 304 are content of energy and nutrients, ingredients, cost, and preparation methods (e.g. grilled, fried, boiled, raw, kosher, etc. . . . ). This information is available at each food establishment FES 110 whose addresses are stored in Authorized FE Servers Database 312. Alternatively, the Food Establishment available food item lists and ingredients may be stored in FE POST 122 devices, as will be explained later and as shown in FIG. 12B.

3. Food Nutrient Content Databases 318 contain the energy content and various macronutrient and micronutrient components for each available food item on FE 100 menu. FIG. 5 (Table 1) shows sample entries of Food Nutrient Database 318.

Personalized Mobile Device Locator 306 locates each registered user device by contacting Location Information 116, which utilizes Global Positioning System (GPS) technology or other location tracking means. The location information will assist the PNMS server 114 in identifying the Food Establishments in the vicinity of the user at the present time; which will assist in authenticating specific FES 110's requesting personal nutrition and medication information about a specific user. This information may also be utilized in certain embodiments to assist the users in locating the Food Establishment with the healthiest selections, based on the analysis performed by PNMS 114.

User, Device, and FES Authentication & Interface Manager 308 verifies the identity of and authenticates each user, device, and Food Establishment Server (FES) 110 attempting to contact server PNMS 114 to read or update registered users' secure customer records 310 or to obtain PNRE 304 food analysis and personalized food item recommendation services. A list of authorized FES 110's and their participating branch stores are kept in database 312.

FIG. 4 shows a view of typical entries of Secure Customer Record Database (SCRD) 310 hosted by PNMS 114, and sample contents of a Secure Customer Record 400 stored in SCRD 310. SCRD 310 has an entry containing the Authorized User ID and Pointer to User Record for each authorized user.

Shown in FIG. 4 is Customer Record 400 for a user with User ID 456 pointed to by address 0x123456. Customer Record 400 contains information utilized by PNMS 114 to authenticate User 456 and registered devices used by User 456 and to authorize their access to the information and services provided by PNMS 114 which are mainly the personalized and recommended food item selections made by PNMS 114 on behalf of the FE 100 guest having User ID 456. Typical entries of Customer Record 400 are:

Encrypted Credentials: such as encryption keys, username, password, and challenge questions and answers used by PNMS 114 to grant User 456, and any of his authorized devices, access to read or update his records and authenticate him as an authorized user of his PNMS 114 Customer Record 400 and nutrition recommendation services.

Auth (orized) Device IDs: contains unique identification information; such as a unique IPv6, hardware MAC ID, or another unique identifier stored in a Personal Identification Card (PIC) 106 for each device authorized to communicate with the PNMS 114 and exchange information on behalf of the user. Example personal devices given in Sample Secure Customer Record 400 are Personal Mobile Device (PMD) 104, Personal Identification Card (PIC) 106, FE PMPD 108, FE POST 122, and Automobiles with displays and Internet access capabilities.

Individualized Energy & Nutrient Budgets and Balances:

Energy Budget: stores user 456's individualized daily target budget of energy (calories) and the range of minimum and maximum recommended grams of each energy contributing macronutrient component; i.e. proteins, fats, and carbohydrates.

Energy Balance: Amounts of energy and its components left for consumption by user 456 for the rest of today. This is calculated as the energy budget minus the energy contained in foods consumed during the day plus energy burnt during physical exercise.

Vitamin Budget: Daily recommended budget of most important vitamins for user 456. Shown in Customer Record 400 are example budgets for Vitamin A, Vitamin C, Vitamin K, and Folate.

Vitamin Balance: Amounts of Vitamins left for consumption by User 456 for the rest of today.

Mineral Budget: Daily recommended budget of most important minerals for User 456. Shown in Customer Record 400 are example budgets for Calcium, Zinc, Manganese, and Potassium. Other users may have a different list of most important minerals based on their assessed nutritional needs.

Mineral Balance: Amounts of Minerals left for consumption by User 456 for the rest of today.

Recommended Phytochemicals & Antioxidants: Quantities of Phytochemical and antioxidant-rich fruits and vegetables recommended for weekly consumption by User 456. The example shown in Customer Record 400 recommends consuming W, X, Y, and Z servings of certain fruits and vegetables with specific colors and high content of antioxidants known to have beneficial health outcomes. Other users may have a different set of fruits and vegetables based on their assessed nutritional needs and availability of certain fruits and vegetables in their locale.

Diet Restrictions: contains any diet restrictions imposed on User 456 for one or more cultural, religious, medical, or lifestyle reasons. PNRE 304 translates these restrictions to filtering any food types or food items containing certain nutrients; which would negatively affect the user's well being if consumed. Example restrictions shown in user record 400 are:

“Vegetarian” diet causes PNRE 304 to filter out all food items containing animal products,

“No alcohol” causes PNRE 304 to filter out any alcoholic beverages or food items, which use alcohol in their preparation,

“Peanut Allergy” causes PNRE 304 to filter out any food items containing peanuts or ingredients prepared in a facility which prepares foods containing peanuts,

“Fried Food” causes PNRE 304 to filter out any fried food items.

HCP Recommended: Any personal dietary guidelines recommended by User 456's Healthcare Professionals responsible for managing User 456's nutrition and overall well-being. Example HCP Recommended dietary guidelines shown in Customer Record 400 are low salt, very low saturated fat, high fiber, and high potassium. Actual numbers for each guideline defined by the HCP will be specified and updated as needed based on changes in User 456's health status.

Medication Management variables: List of all prescription and non-prescription medications taken by user 456 which have positive or negative effects or interactions with nutrients along with additional information used by the PNRE 304 during the personalized menu item selection process. The User's healthcare providers typically define this information. Example variables shown in Customer Record 400 are medication names, timing (take on empty stomach, before meal, after meal, etc), times taken and any known interactions with certain food items. The interaction information is used by PNRE 304 to determine whether or not these foods should be selected for consumption at the present time or delayed by a period of time specified by the HCP as safe to consume.

Favorite Foods: is another variable that is used by the PNRE 304 during the personalized menu item selection process, which gives favorite foods higher ranks than other foods if the energy and nutrient balances are not exceeded and are well balanced. Example favorite foods shown in Customer Record 400 are mangos, pizza, salads, and grilled foods.

FIG. 5 shows Sample entries of Food Nutrient Content Database 318, as Table 1. Each food entry in Table 1 shows the energy and nutrient contents per 100 grams of the specific type of food. Other units may be used if deemed more convenient. The food item energy & nutrient content information is used to evaluate each food item's rank for presentation to the Food Establishment 100 guests. As mentioned before, the food items containing the most nutrients needed by the requesting guest without exceeding his energy budget balance will be candidates for inclusion in the personalized list of food items. This of course assumes that the food item has not been filtered out due to the criteria described above; such as allergies, medication interaction, and/or cultural, religious, etc reasons.

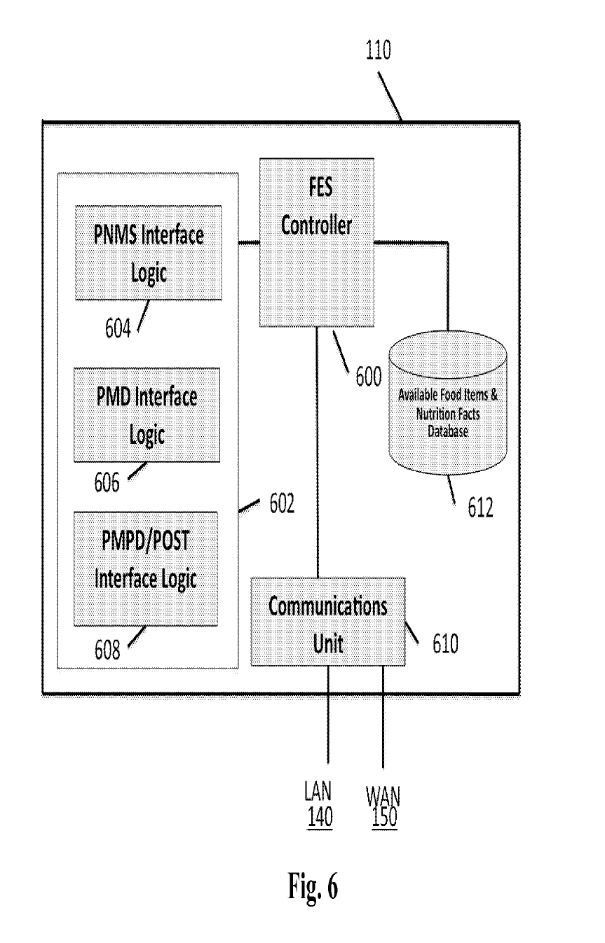

FIG. 6 shows the major building blocks of a typical Food Establishment Server FES 110. FES 110 main responsibility is to keep a current list of Available Food Items and associated nutrient and ingredient information for each FE 100 utilizing the individualized menu composition method and system described herein. FES 110 may be located on the Food Establishment 100 premises and accessible via network LAN 140, or it may be located in a remote area or in the Internet cloud in which case it will be accessible via network WAN 150.

FES 110 is comprised of:

FES Controller 600; which can be implemented using off-the-shelf or custom computer server components and is responsible for program execution and data storage services for all functions implemented by server FES 110.

Communications Unit 610, which enables FES 110 to communicate with devices and entities over LAN network 140 and WAN network 150.

Available Food Items & Nutrition Facts Database 612 contains the available food item information for all participating FE 100 locations.

Memory subsystem 602 which houses the machine readable instructions executed by FES Controller 600 to realize functions 604, 606, and 608 described below.

FES 110 is responsible for performing the following functions:

PNMS Interface Logic 604 manages the communications between FES 110 and PNMS 114. Typical communications usually have one of the following goals:

FES 110 receives the personal identification information of a specific guest at a specific FE 100 from FE POST 122 or FE PMPD 108, which obtain this information from the PIC 106 or PMD 104 devices belonging to the specific guest at the specific FE 100 location. This information is sent to PNMS 114 utilizing Communication Unit 610.

FES 110 also utilizes Interface Logic 604 to upload to PNMS 114 the list of available food items at the specific FE 100, stored in database 612 and is utilized by PNMS 114 for composing a personalized list of menu items for the specific guest whose identification information was obtained by PNMS 114 according to the personalization process described earlier. The composed personalized list of menu items is sent by PNMS 114 to FES 110 who then delivers it to the requesting FE PMPD 108 and/or FE POST 122 devices for presentation to the specific FE 100 guest.

Personalized Mobile Device (PMD) Interface Logic 606: As shown in FIG. 12.1 and as will be described later in this specification, some advanced PMD 104 devices implemented in certain embodiments of the present invention are capable of constructing personalized menus for their owners by obtaining the Available Food Item information stored in Available Food Item & Nutrition Facts Database 112 by contacting FES 110. PMD Interface Logic 606 manages the authentication of and communications with the Personalized Mobile Device (PMD) 104 that belongs to a guest of an FE 100 and contains the authentication information for said guest.

PMPD/POST Interface Logic 608 manages the authentication of and communications between FES 110 and Food Establishment's Personalized Menu Presentation Devices (FE PMPD) 108 and FE POST 122 devices present at or in the vicinity of a specific FE 100 location. This communication is typically established to accomplish the following:

1. Provide the FE PMPD 108 with the personalized food item list obtained by FES 110 from PNMS 114 that prepared it on behalf of a specific guest with a PIC 106 desiring to utilize the UI presentation and selection resources of FE PMPD 108. PIC 106 provides FE PMPD 108 its identification information which is then passed over to FES 110 which in turn provides it to PNMS 114 which then authenticates the PIC 106 user and utilizes the information stored in his personal record 400, along with FES 110's Food Establishment Available Food Items & Nutrition Facts Database 112 entries that belong to the specific FE 100 to which the requesting FE PMPD 108 belongs.

2. Provide a specific FE POST 122 access to Food Establishment Available Food Items & Nutrition Facts Database 112 entries that belong to the specific FE 100 to which this specific FE POST 122 belongs. Such food items and nutrition facts information is then transferred to and utilized by an embodiment of PMD 104 not capable of directly communicating with FES 110 to construct the personalized set of food items for its owner.

Shown in FIG. 7 is store 57's Food Establishment Available Food Items & Nutrition Facts Database 112, which has 3 entries identifying each currently Available Menu Item at this particular FE 100 (Store 57):

Available Menu Item and Price: this is a dynamic list showing all available food items at store 57 at the present time with their respective prices. New items (e.g. Chef Specials, Catch of the Day) can be added and existing items can be removed by store 57 management (e.g. when store runs out of any items).

Ingredients: this variable points to a list of ingredients 702 and their amounts constituting each food item currently available at store 57. The ingredients information is used in the menu item removal steps of certain embodiments of the present invention to allow the removal of menu items containing ingredients which could cause harm to the users. These could be ingredients which cause allergic reactions or may interact with certain medications taken by the user, as will be explained below.

Nutrition Values: this points to a list 700 containing the values of total amount of energy, macronutrient components (e.g. carbohydrates, protein, fats, fiber) and micronutrients (e.g. vitamins, minerals, phytochemicals, antioxidants) contained in each available food item. The Nutrition Values information is used in the food item portion adjustment steps of certain embodiments of the present invention to allow the adjusted food items to have energy and nutritional contents which are within the user's remaining energy and nutrient budget balances and below any upper limits of certain nutrients.

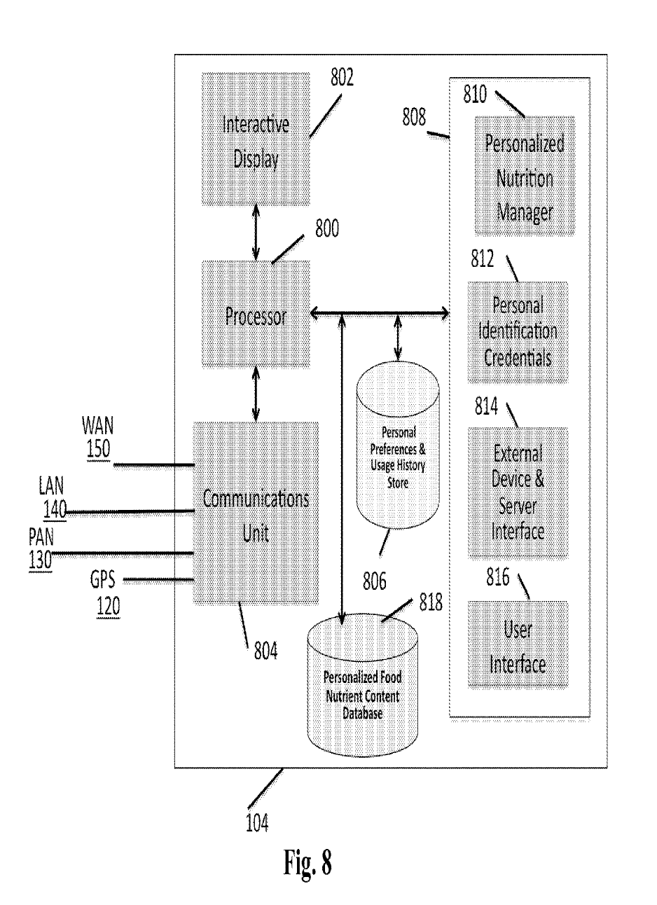

FIG. 8 shows the main building blocks of a Personalized Mobile Device (PMD) 104 to be utilized in sample embodiments of the present invention. PMD 104 is constructed of the following components:

Processor 800: Can be any off-the-shelf or custom microprocessor or Application Specific IC (ASIC) capable of carrying on the execution and communication tasks described herein.

Interactive Display 802: Although any display and keyboard would provide the desired interactive user interface functionality, the preferred embodiments will have a display with touch screen similar to those utilized by consumer electronic devices such as telephones and portable personal computers.

Communications Unit 804: is implemented from communications transceivers and communications software and logic to enable PMD 104 to communicate with devices and other computing entities over GPS link 120, PAN network 130, LAN network 140 and WAN network 150.

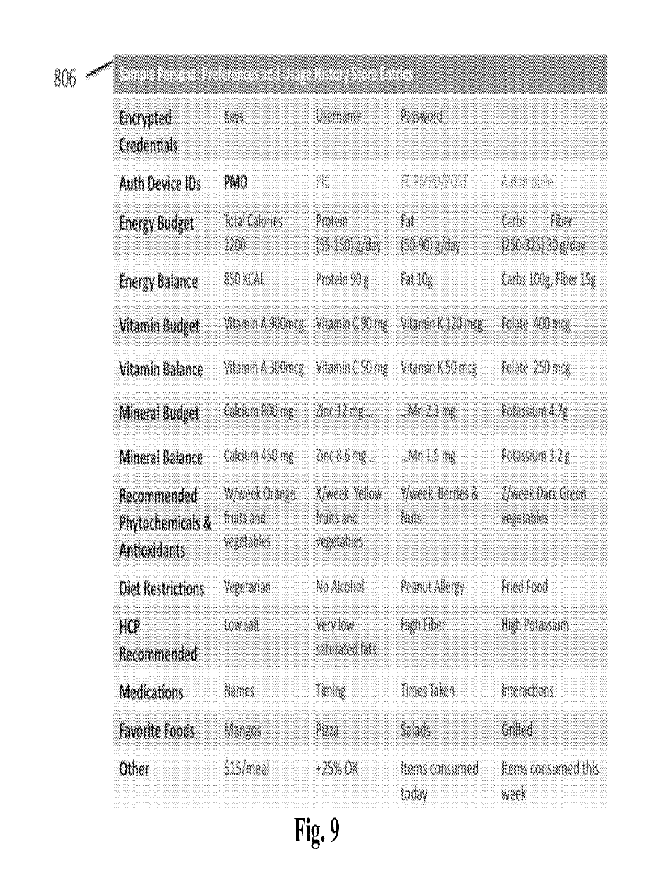

Personal Preferences & Usage History Store 806: is implemented from non-volatile memory components and stores a copy of the PMD 104 owner's personal and health-related information to be utilized in some embodiments of the present invention. A typical set of such personal information and usage history is shown in FIG. 9.

Memory subsystem 808: is implemented from volatile or non-volatile memory components and houses the machine readable data and instructions executed by Processor 800 to realize the intended functionality of PMD 104:

Personalized Nutrition Manager 810: responsible for managing User1 102's overall nutrition budgets and reporting usage information to PNMS 114, if applicable.

Personal Identification Credentials 812: are comprised of the information needed to authenticate PMD 104 to other devices and entities it needs to communicate with in order to perform the functions it is responsible for. These credentials, such as username and password, are usually encrypted using private and public encryption keys.

External Device & Server Interface 814: is responsible for establishing communications and exchanging relevant information with external devices and servers, such as FE POST 122, FE PMPD 108, FES 110, and PNMS 114.

User Interface 816: is responsible for displaying information and accepting user selections for the various functions provided by PMD 104.

Optional component—Personalized Food Nutrient Content database 818: More capable PMD 104 devices implemented according to embodiments of the present invention can maintain a Personalized Food Nutrient Content database 818. This database only contains the nutrient contents for those items of interest to PMD 104 owner, User1 102. The items of interest are comprised of a combination of subset of food items present in Food Nutrient Database 118, food items prepared according to special recipes, frequently eaten restaurant food items, etc.

FIG. 9 shows the main entries of a Sample Personal Preferences and Usage History Store 806 described earlier. These are almost identical to Sample Secure Customer Record 400 described early. One exception is the Authorized Device ID's field in Personal Preferences & Usage History Store 806 only shows this particular PMD 104's device ID and not the IDs for other devices such as PIC 106, FE POST 122, and FE PMPD 108.

The sample Personal Preference & Usage History Store 806 shown in FIG. 9 has an additional entry, named Other, where additional user preferences and usage history items are defined. For example, the first item $15Meal signifies that this particular User1 102 would like to spend no more than $15/meal. The next variable, +25% OK, signifies that this particular User1 102 is willing to spend an additional 25%, or $3.75, per meal. These two variables will be used, as described below, to remove any items from the food established menus which are priced higher than the desired monetary budget of $18.75 set by the user. These are exemplary monetary budgets and each user can determine their own amounts.

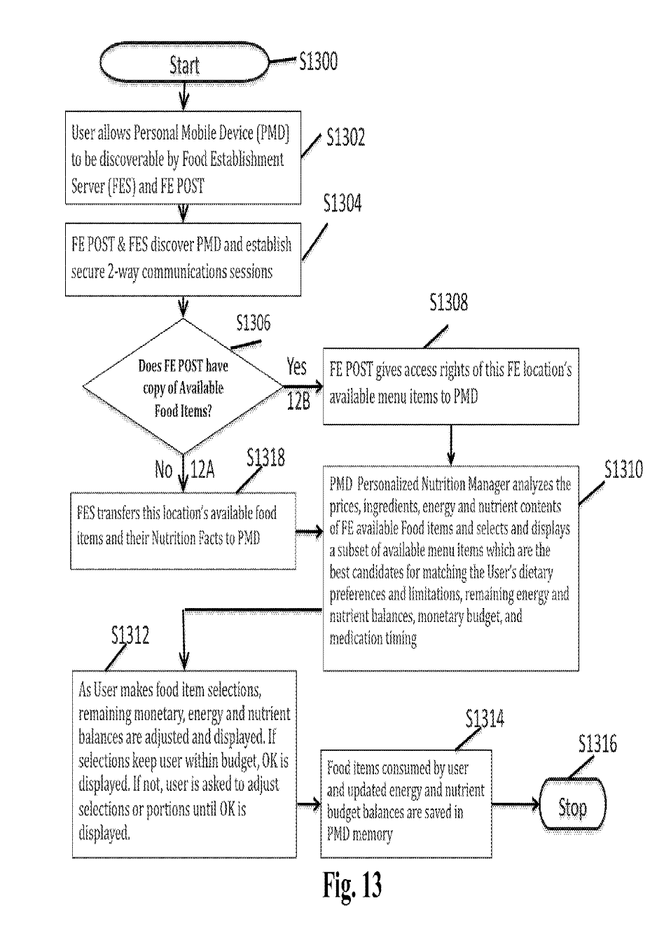

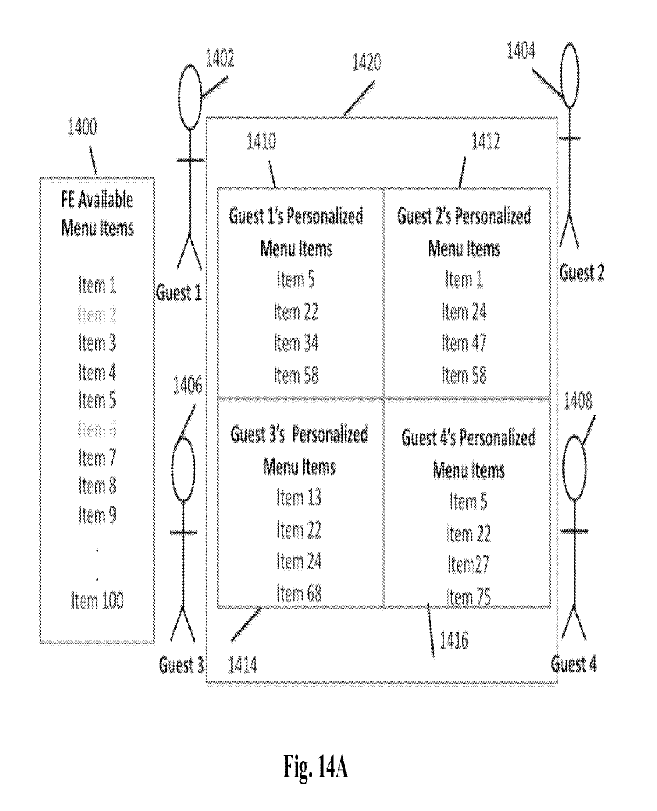

The next variable, Items Consumed Today, keeps a list of all food items and their energy and nutritional contents that are consumed during the day, as indicated by the user during the food item selection process described in more detail in FIGS. 13, 16, and 18.

The next variable, Items Consumed This Week, keeps a list of all food items consumed by User1 104, during the last week. One usage for this information is for nutritionists who are monitoring User1 102's eating behaviors in order to give their customers nutritional advice, if needed. Another benefit of having access to the Items Consumed This Week variable is by having data mining and analytics engines analyze this data to get a snapshot of User1 102's typical dietary intake of energy and nutrients. If it is determined that there is a deficiency in certain nutrients, User1 102's budgets of the deficient macronutriens and micronutrients are increased, which would result in increasing the ranks of food items containing high amounts of these nutrients. Alternatively or additionally, nutritional supplementation for the nutrients which are lower than the minimum requirements for User1 102 may be recommended. Similarly, data analysis may determine that User1 102 is consuming amounts of certain nutrients which are higher than the individualized upper limits, which may cause harm if consumed over a long period of time. In this case, User1 102's upper limits for the offending nutrients will be lowered which will result in a reduction of the amounts and portions of foods which contain these nutrients, as well as a reduction of any nutritional supplements containing the offending nutrients which User1 102 may be taking.

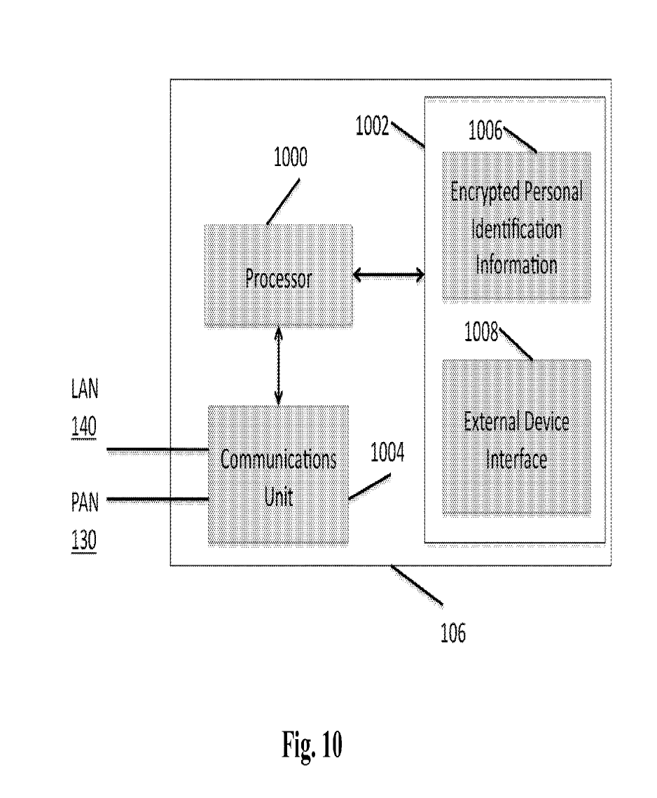

FIG. 10 shows the main building blocks of a Personal Identification Card (PIC) 106 to be utilized in some embodiments of the present invention. The main advantage of using PIC 106 devices is their lower complexity and lower cost, as compared to PMD 104 devices. PIC 106 is comprised of the following components:

Processor 1000: Can be any off-the-shelf or custom microprocessor or Application Specific IC (ASIC) capable of carrying on the execution and communication tasks described herein.

Memory subsystem 1002: is implemented from volatile or non-volatile memory components and houses the machine readable data and instructions executed by Processor 1000 to realize the intended functionality of PIC 106:

Encrypted Personal Identification Information 1006 is comprised of identification information sufficient to uniquely identify the PIC 106 cardholder User2 103 to PNMS 114 in order to authenticate User2 103 as a valid subscriber to its personalized food item preparation services and release User2 103's personal information to the requesting entities.

External Device Interface 1008 is responsible for establishing communications and exchanging relevant information between PIC 106 and external devices, such as FE POST 122 and FE PMPD 108.

Communications Unit 1004: is implemented from communications transceivers and communications software and logic to enable PIC 106 to communicate with devices and other computing entities over PAN network 130 and/or LAN network 140.

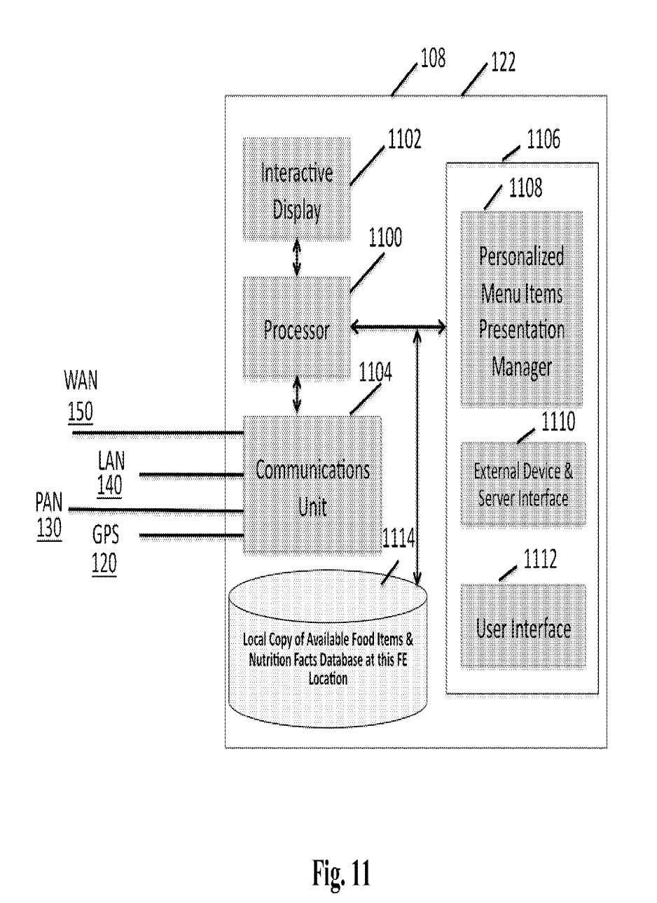

FIG. 11 shows the main building blocks of a Food Establishment's Personalized Menu Presentation Device (FE PMPD) 108 to be utilized in some embodiments of the present invention. Food Establishment Point of Sale Terminal (FE POST) 122 has the same building blocks as FE PMPD 108.

The main differences between the FE PMPD 108 and FE POST 122 devices is in how they are used; the PMPD 108 is used by guests with UI-challenged PIC 106 devices to view available menu items at a certain FE 100, while the FE POST 122 devices are used by the guest's PMD 104 device as a gateway to access and transfer the available menu item information to PMD 104 for constructing and presenting the individualized menu items to User1 102 on the PMD 104 display. These are to main building blocks of typical embodiments of FE PMPD 108 and FE POST 122:

Processor 1100: Can be any off-the-shelf or custom microprocessor or Application Specific IC (ASIC) capable of carrying on the execution and communication tasks described herein.

Interactive Display 1102: Although any display and keyboard would provide the desired interactive user interface functionality, the preferred embodiment has a display equipped with a touch screen similar to those utilized by consumer electronic devices such as telephones and portable personal computers.

Communications Unit 1104: is implemented from communications transceivers and communications software and logic to enable FE PMPD 108 and FE POST 122 to communicate with devices and other computing entities over GPS link 120, PAN network 130, LAN network 140 and WAN network 150.

Memory subsystem 1106: is implemented from volatile or non-volatile memory components and houses the machine readable data and instructions executed by Processor 1100 to realize the intended functionality of FE PMPD 108 and FE POST 122:

Personalized Menu Items Presentation Manager 1108 is responsible for managing User1 102's overall nutrition budgets and reports usage information to PNMS 114, if applicable.

External Device & Server Interface 1110 is responsible for establishing communications and exchanging relevant information with external devices and servers, such as PMD 104, PIC 106, and FES 110.

User Interface 1112 is responsible for displaying information and accepting user selections for the various functions provided by FE POST 122 and FE PMPD 108.

Optional—Local Copy of Available Food Items & Nutrition Facts Database 1114: Some embodiments of the FE PMPD 108 and FE POST 122 devices will prefer to not utilize the services of an FES 110 and will maintain a local copy of the available food item information at the FE 100 in the FE PMPD 108 and FE POST 122 devices located at this FE 100. Such an embodiment of FE POST 122 is shown in FIG. 12B.

FIG. 12A is a depiction of an embodiment of the present invention where User1 102 has an autonomous PMD 104, which has its own copy of Personalized Food Nutrient Content Database 818 and Personalized Nutrition Manager 810 as previously described and shown in FIG. 8. In this case, there is no need for the food item personalization services of PNMS 114. However, Food Establishment POST 122 does not have a local copy of Available Food Items & Nutrition Facts Database to provide to PMD 104 which would require PMD 104 to communicate with FE 110 to obtain the list of currently available food items at FE 100, along with each item's price and corresponding nutrition facts. Personalized Nutrition Manager 810 constructs User 1 102's personalized food item list and provides it to User Interface 816, which displays it on Interactive Display 802 for User1 102's selection. A step-by-step sequence of events for this embodiment is shown in FIG. 13.

FIG. 12B is a depiction of an embodiment of the present invention where User1 102 has an autonomous PMD 104, which has its own copy of Personalized Food Nutrient Content Database 818 and Personalized Nutrition Manager 810 previously described and shown in FIG. 8. Additionally, FE 100 has an autonomous FE POST 122, which has a copy of the currently Available Food Items & Nutrition Facts database 1114 as shown in FIG. 11. In this case, there is no need for the food item personalization services of PNMS 114 or available item list services of FES 110. PMD 104 obtains the list of currently available food items at FE 100, along with each item's price and corresponding nutrition facts from FE POST 122. Personalized Nutrition Manager 810 constructs User 1 102's personalized food item list and provides it to User Interface 816, which displays it on Interactive Display 802 for selection by User1 102. A step-by-step sequence of events for this embodiment is shown in FIG. 13.

FIG. 13 is a flowchart that describes the steps involved in implementing embodiments of the present solution for the use cases shown in FIGS. 12A and 12B, whereby User1 has an autonomous personalized mobile device, PMD 104, with its own copy of personalized food nutrient database.

Step S1300 starts the sequence of steps, when User1 102 turns on the food item personalization process when he is in the vicinity of an FE 100 and desires to see the available food items, which are most fit for his health and personal preferences.

In step S1302 User1 102 enters a command into PMD 104's user interface, which gives permission to FES 110 and FE POST 122 to discover the presence of PMD 104. The discovery process usually starts by PMD 104 announcing its presence over one or more PAN 130, LAN 140, and WAN 150 networks.

In step S1304, FE POST 122 and FES 110 discover the presence of PMD 104 and establish 2-way communication on one or more of the networks on which they usually listen for the presence of PMD 104 devices.

In step S1306 PMD 104 asks FE POST 122 if it is capable of providing ingredient and nutrition facts information for FE 100's available food items. If the answer is affirmative, (use case shown in FIG. 12B), FE POST 122 allows PMD 104 to access the available food item list and associated ingredient and nutrient facts information available in database 1114.

Control then advances to step S1310 where PMD 104's Personalized Nutrition Manager 810 then uses User1 102's personal information stored in PMD 104's Personal Preferences & Usage History Store 806 to analyze the prices, ingredients, energy and nutrient contents of FE 100 available Food items stored in database 1114 and selects and displays a ranked subset of available menu items which are the best candidates for User1 102's monetary budget, dietary preferences and restrictions, remaining energy and nutrient balances, and medication timing.

A list of a sample set of rules and process steps implemented by an embodiment of PMD Personalized Nutrition Manager 810 for creating the preferred subset of available food items for User1 102 may look like this:

1. Remove certain food items which contain ingredients that are restricted for User1 102. An example of the ingredients of one of the available food items is shown in table 702 shown in FIG. 7. The restricted ingredients for each user are determined according to the contents of the following variables available in User1 102's Sample Personal Preferences and Usage History Store Entries 806 shown in FIG. 9:

Diet Restrictions: Remove all animal products for strict Vegetarians (i.e. Vegans). Keep dairy and egg products for Lacto Ovo Vegetarians. Remove all food item products containing Alcohol if it is in the Diet Restrictions list. The same is done for food items containing peanuts or are fried.

Permanent and Temporary Medication interactions: Remove all food items, which are known to contain ingredients that interact negatively with medications taken recently or scheduled to be taken soon by User1 102. If the interaction is temporary, for example the offending food item will be consumed less than 2 hours after the medication was taken or the medication is due to be taken less than 1 hour after the offending food item is consumed, a timer is set to remove the food item from the available food item list for the duration of the stated interaction blackout time.

2. Monetary Budget Restrictions: Remove all food items that are priced more than X % of the user's preset budget. X is a user-defined variable. FIG. 9 shows a budget of $15 per meal with a margin X of 25%. This means that food items costing more than $18.75 will not be included in User1 102's subset of recommended food items.

3. Reduce the portion sizes of certain remaining food items, which if taken in their normal serving sizes would cause the upper limits of calories and certain nutrients to be exceeded. This requires comparing the energy and nutrient contents of each available food item listed in table 700 shown in FIG. 7 to the remaining balances of Energy, Vitamins, and Minerals contained in User1 102's Sample Personal Preferences and Usage History Store Entries 806, shown in FIG. 9, and adjusting the portion size so that the adjusted energy and nutrient contents do not exceed the remaining energy balance or nutrient upper limits.

4. Rank the remaining food items (including the food items with the reduced portion sizes calculated in step 3 above) according to each food item total nutritional score, HCP Recommendations for User1 102, and list of Favorite Foods both shown in table 806 in FIG. 9: One method of calculating the total nutritional score is based on comparing the food item's nutrient contents (found in Personalized Food Nutrient Content Database 818) with User1 102's remaining energy, vitamin, and mineral balances shown in table 806. Highest score may be given to items with the least amount of calories and saturated fats and the most amounts of macronutrients, vitamins and minerals of which User1 102 has high remaining balances (meaning they are needed the most by User1 102's body). The lowest scores may be given to food items high in calories but low in needed nutrients.

Other factors may be considered in calculating the nutritional scores, such as phytochemical and antioxidant contents. The scoring method is flexible and programmable and should be individualized to meet different users needs. A nutrition expert will have the final say in the total nutritional scoring algorithm to be included in each user's PMD 104's Personalized Nutrition Manager 810.

The highest food items ranks will be given to those food items that meet the HCP recommendations (e.g. low salt, low saturated fats, high in fiber and potassium) AND are on User1 102's favorite food list (e.g. mangos, pizza, salads, grilled foods) AND have the highest total nutritional score.

If the answer to the question asked in step S1306 is negative, meaning that FE POST 122 does not have a copy of FE 100's available food item list and associated monetary limits and nutrition facts, this means we have the usage configuration shown in FIG. 12A which means FES 110 must be contacted to obtain access to FE 100's Available Food Item & Nutrition Facts Database 112.

Control advances to step S1318 where PMD 104 receives access to database 112. These are 2 example embodiments to accomplish this task:

1. PMD 104 may be able to communicate directly with FES 110 over LAN 140 or WAN 150 and request access to database 122. Access will be granted if FES 110 can authenticate PMD 104 by checking the validity of PMD 104's Encrypted Credentials stored in Personal Preferences & Usage History Store 806, shown in FIG. 9.

2. If PMD 104 is not able to directly communicate with FES 110, then PMD 104 may provide its Encrypted Credentials to FE POST 122 and requests it to contact FES 110 and obtain access to database 112 on its behalf.

Once PMD 104 has access to the contents of database 112, control advances to step S1310 described above.

The next step after the completion of step S1310 is S1312 where User1 102 makes his food item selections from the personalized food item list presented by User Interface 816 on PMD 104's Interactive Display 802. As User1 102 selects all the food items he plans to consume, Personalized Nutrition Manager 810 adjusts the potentially remaining energy and nutrient balances, which are then displayed by User Interface 816 on Interactive Display 802.

If the selections keep User1 102 within the remaining individualized energy and nutrient budget balances given in table 806, OK is displayed. If not, User1 102 is asked to make adjustments to his food item selections and/or portions until OK is displayed.

Control then advances to step S1314 where the updated energy and nutrient budget balances, as well as the food items consumed, are saved in PMD 104's Personal Preferences & Usage History Store 806. The food item personalization procedure ends at step S1316.

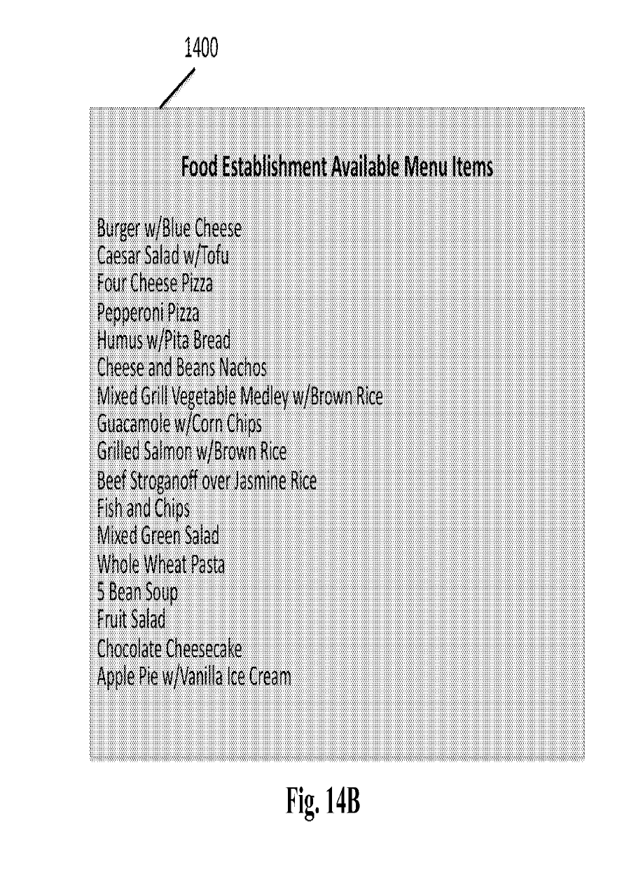

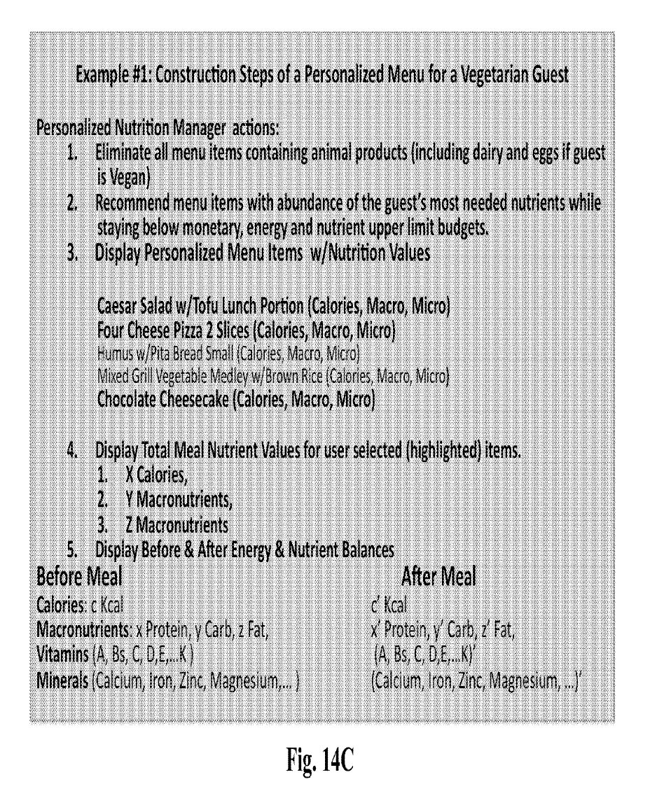

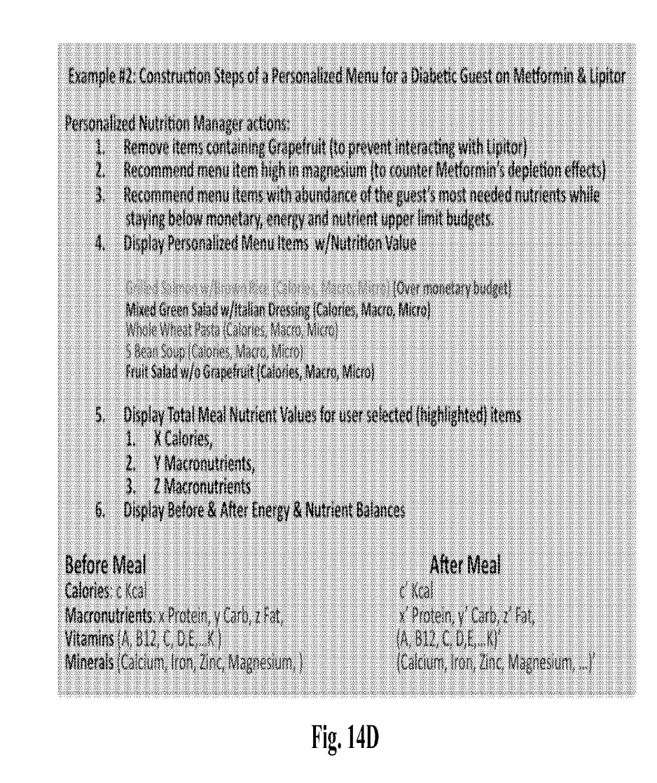

FIG. 14A shows a view of the personalized menu presentations to multiple FE 100 guests in one embodiment of the present invention. In this example, FE Available Menu Items 1400 has a list of 100 food items usually offered to guests of food establishment FE 100. The grayed out items, such as Item 2 and Item 6 are not available due to many reasons such as unavailability of ingredients and more customer demand than the on-hand supply. The rest of the items are currently available at food establishment FE 100.

4 guests are shown in FIG. 14A getting food services from FE 100; they are namely Guest 1 1402, Guest 2 1404, Guest 3 1406, and Guest 2 1408. In front of each guest is a display showing a list of this guest's personalized menu items. Guest 1, Guest2, Guest3, and Guest4's Personalized Menu Items are shown on displays 1410, 1412, 1414, and 1416, respectively.

As can be seen, each Guest has a different set of food items which was personalized according to the embodiment of the present invention as was described earlier in FIGS. 12A, 12B, and 13.

In one embodiment, the displays 1410-1416 can be those of each guest's PMD 104 device.

Alternatively, they may be displays of store-provided Personalized Menu Presentation Devices (PMPD) 108.

In some embodiments of the present invention FE 100 may chose to provide PMPD 108 devices embedded in the table 1420 at which Guests 1402-1408 are seated.

Alternatively, integrated display 1420 can be implemented at one of the user's home TV screen if virtual ordering is preferred.

Each guest would interact with the interactive display in front of him to view and order food items from his Personalized Food Item List.

FIG. 14B shows an example of a list of actual food items comprising a Food Establishment Available Menu Items 1400.

FIG. 14C shows an example of the steps taken by Personalized Nutrition Manager 810 to personalize a menu of food items out of the available food items list 1400 for a Vegetarian guest.

Step 1 eliminates all the food items in list 1400 with animal product contents.

Step 2 keeps only items which satisfy the user's remaining balances of energy, macronutrients, and micronutrients.

Step 3 presents the recommended items to the user, and shows as highlighted those items that were selected by the user.

Step 4 shows the user the total energy and nutrient contents of the selected items.

Step 5 shows the user's balances of energy, macronutrients, and micronutrients before and after consuming the ordered food items.

FIG. 14D shows an example of the steps taken by PMD 104's Personalized Nutrition Manager 810 to personalize a menu of food items out of the available food items list 1400 for a Diabetic guest taking the diabetes management medication Metformin and cholesterol-lowering medication Lipitor.

Step 1 eliminates any items containing Grapefruit to avoid negative interaction with Lipitor taken by the user.

Step 2 find and recommends menu items high in magnesium (to counter Metformin's magnesium depleting effects).

Step 3 recommends items that contain an abundance of the guest's most needed nutrients while staying below energy and nutrient upper limit budgets.

Step 4 presents the recommended items and shows as highlighted, those items selected by the user.

Step 5 shows the user the total energy and nutrient contents of the selected items.

Step 6 shows the user's balances of energy, macronutrients, and micronutrients before and after consuming the ordered food items.

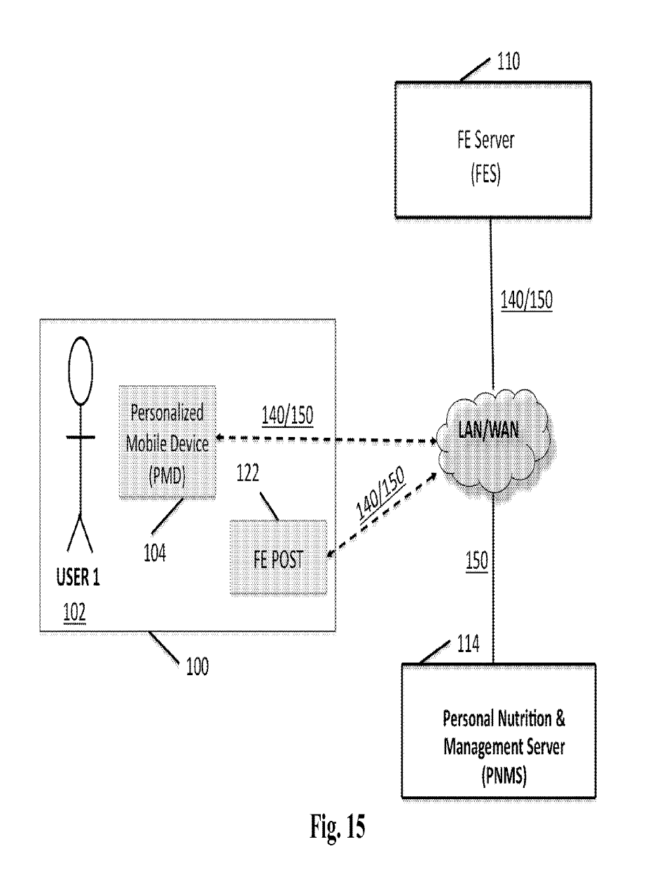

FIG. 15 is a depiction of an embodiment of the present invention where User1 102 has a less capable PMD 104 as compared to the PMD 104 described in FIGS. 12A and 12B.

This embodiment of PMD 104 does not have its own copy of the Optional Personalized Food Nutrient Content database 818 and is thus dependant on Personal Nutrition Management Server (PNMS) 114 for constructing a personalized subset of FE 100 available menu items for User1 102 to view and make food selections. PMD 104 may be able to communicate with PNMS 114 over WAN 150 or by contacting FE POST 122 or FES 110 to communicate with PNMS 114 over WAN 150 on its behalf.

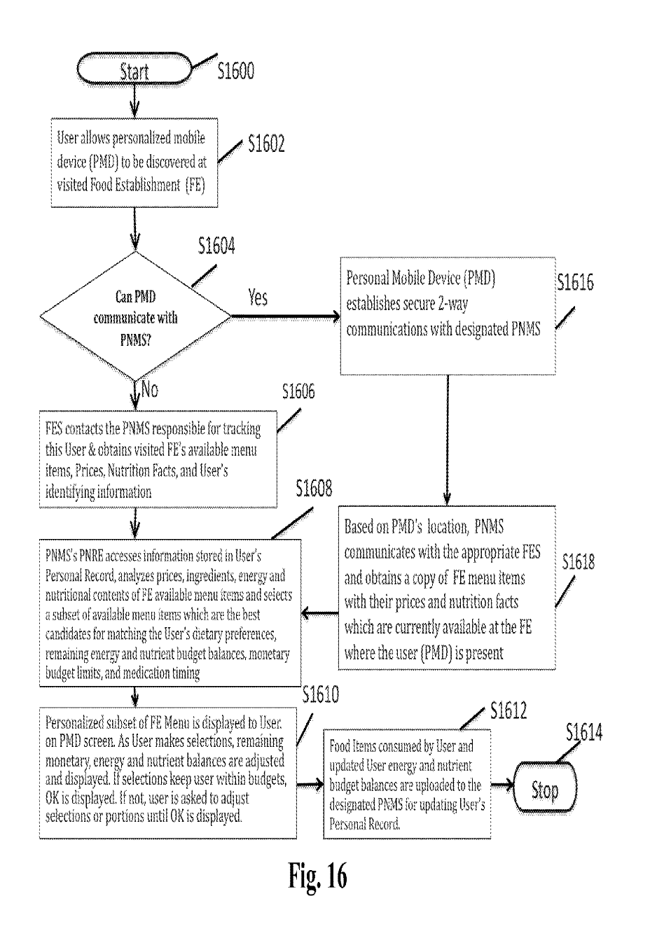

FIG. 16 is a flowchart that describes the steps involved in implementing an embodiment of the present invention shown in FIG. 15, where User1 102 has a PMD 104 which relies on Personal Nutrition Management Server (PNMS) 114 for constructing the personalized subset of FE 100's available menu items.

The first step is S1600, which is entered upon User1 102 enabling of the food item personalization function on PMD 104.

Control advances to step S1602 where User1 102 enables device PMD 104 to be discoverable by other computing entities associated with FE 100, such as FE POST 122 and FES 110.

In step S1604, PMD 104's Personalized Nutrition Manager 810 inquires from the Communications Unit 804 if PMD 104 is able to communicate with PNMS 114.

If the answer is affirmative, control moves to step S1616 where PMD 104 establishes a secure 2-way communications session with PNMS 114 over network WAN 150 and provides it with its encrypted credentials.

Based on this information, in step S1618, PNMS 114 utilizes the services of Personalized Mobile Device Locator 306 to find the location of PMD 104, which is in the vicinity of FE 100 as indicated in. PNMS 114, then contacts server FES 110 responsible for serving this location and obtains a copy of the FE Available Food Items & Nutrition Facts Database 112 which contains the presently Available Food Items on FE 100's menu, along with the prices and nutrition facts for each food item.

Next, in step S1608, PNMS 114's Personalized Nutrition Recommendation Engine (PNRE) 304 accesses information stored in Secure Customer Record Database 310, analyzes prices, ingredients, energy and nutritional contents of FE 100 available menu items and selects a subset of available menu items which are the best candidates for matching the User's dietary preferences, remaining energy and nutrient budget balances, monetary budget limits, and medication timing. This is the same food item personalization procedure described earlier for FIG. 13 step S1310.

Control then advances to step S1610 where User1 102 makes his food item selections from the personalized food item list presented by User Interface 816 on PMD 104's Interactive Display 802. As User1 102 selects all the food items he plans to consume, Personalized Nutrition Manager 810 adjusts the remaining energy and nutrient balances, which are then displayed by User Interface 816 on Interactive Display 802. If the selections keep User1 102 within the individualized energy and nutrient budgets given in table 806, OK is displayed. If not, User1 102 is asked to make adjustments to his food item selections and/or portions until OK is displayed.

Control then advances to step S1612 where the updated energy and nutrient budget balances are uploaded to PNMS 114, which updates User1 102's Secure Customer Record in database 310. The food item personalization procedure ends at step S1614.

Now, if the answer to question S1604 was negative (NO), meaning this is an embodiment where FES 110 is able to communicate with PMD 104 over communication networks LAN 140 or WAN 150, control advances to step S1606 where either FES 110 or FE POST 122 establishes communication with PMD 104 and extracts its Encrypted Personal Information and then contacts PNMS 114 & obtains visited FE 100's available menu items and their prices, Nutrition Facts, and User's identifying information.

Control then advances to step S1608 and the food item personalization procedure completes as described above.

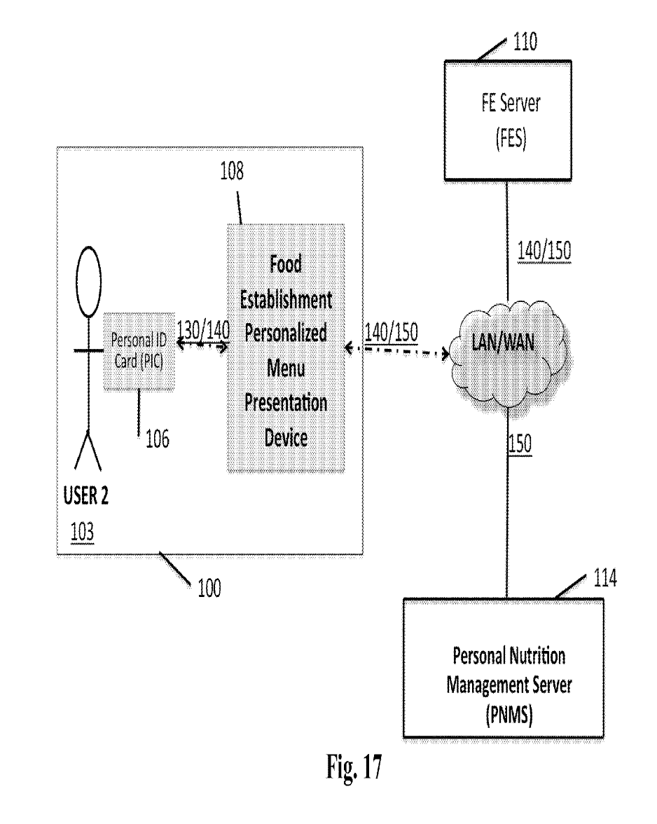

FIG. 17 is a depiction of an embodiment of the present invention where User2 103 has a PIC 106 and utilizes the proxy services of FE PMPD 108 to communicate with FES 110 and PNMS 114 for constructing and downloading the personalized food/menu items to FE PMPD 108 for viewing and selections by User2 103.

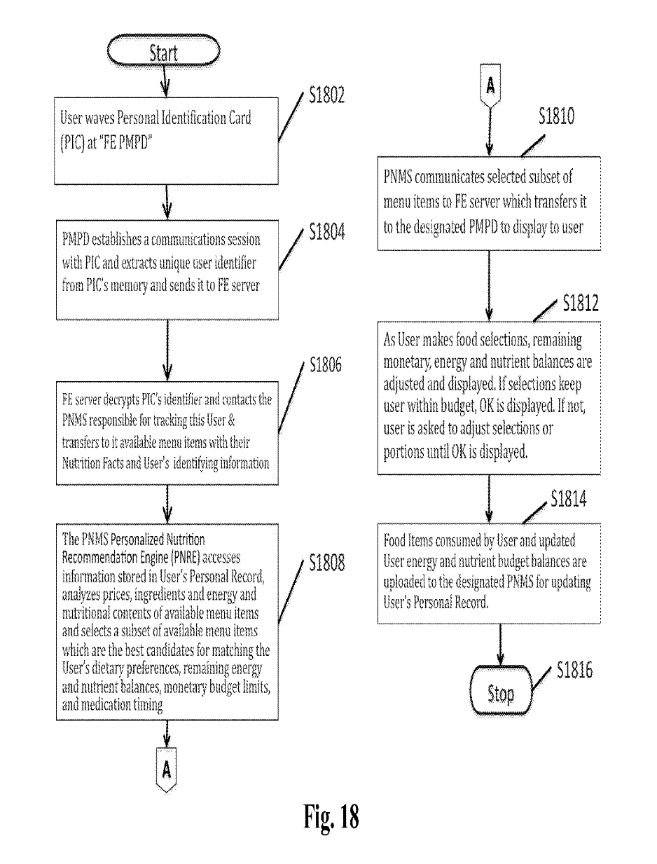

FIG. 18 is a flowchart that describes the steps involved in the implementation of an embodiment of the present invention shown in FIG. 17, where User2 103 has a Personal Identification Card (PIC) 106 and relies on the User Interface of FE PMPD 108 for displaying the individualized menu item subset and selection of food items. The personalized food item list construction procedure starts in step S1802 when User2 103 waives his PIC 106 at an FE PMPD 108 available at FE 100. FE PMPD 108 establishes a communications session with PIC 106 over PAN 130 or LAN 140 and extracts the Encrypted Personal Identification Information 1006 from PIC 106's Memory Subsystem 1002 and sends it to FES 110 over LAN 140 or WAN 150.

In step S1806, FES 110 decrypts PIC 106's identifier 1006 and contacts the PNMS 114 responsible for managing the nutrition of this User2 103. FES 110 transfers PIC 106's identification information to PNMS 114 along with FE 100's available menu items with their Nutrition Facts 612.

In step S1808, PNMS 114's Personalized Nutrition Recommendation Engine (PNRE) 304 accesses information stored in Secure Customer Record Database 310, analyzes ingredients, energy and nutritional contents of FE 100 available menu items and selects a subset of available menu items which are the best candidates for matching the User's dietary preferences, remaining energy and nutrient balances, monetary budget limits, and medication timing. This is the same food item personalization procedure described earlier for FIG. 13 step S1310.

In step S1810, PNMS 114 communicates the selected subset of FE 100's available food items and their nutrient facts, as well as User2 103 remaining energy and nutrient balances to FES 110, which transfers this information to the designated PMPD 108 over LAN 140 or WAN 150 to display to User2 103.

In step S1812, User2 103 makes his food item selections from the personalized food item list presented by User Interface 1112 on FE PMPD 108's Interactive Display 1102. As User2 103 selects all the food items he plans to consume, Personalized Menu Item Presentation Manager 1108 adjusts the remaining energy and nutrient balances, which are then displayed by User Interface 1112 on Interactive Display 1102. If the selections keep User2 103 within the individualized energy and nutrient budgets, OK is displayed. If not, User2 103 is asked to make adjustments to his food item selections and/or portions until OK is displayed.

Control then advances to step S1814 where the updated energy and nutrient budget balances are uploaded to PNMS 114, which updates User2 103's Secure Customer Record in database 310. The food item personalization procedure ends at step S1816.

It is to be understood that the above described features can be achieved by a method in which a storage medium is supplied to a system or device, the storage medium having computer-executable instructions for realizing the above described operations, and a computing device (e.g., CPU and MPU) for the system or device that reads the computer-executable instructions stored in the storage medium and executes them.

In this case, the computer-executable instructions when read from the storage medium and performed by the computing device execute the operations of the above-described embodiments. Thus, the computer-executable instructions or the storage medium storing the computer-executable instructions therein constitute an embodiment.

As a storage medium for supplying the computer-executable instructions (e.g., a floppy disk, a hard disk, an optical disk, a magneto-optical disk, a CD-ROM, a CD-R, a magnetic tape, a non-volatile memory card, and a ROM) any applicable computer-readable storage medium can be employed.

When the computer-executable instructions are executed by a computing system, not only are the above-described operations of the embodiments realized, but also an operating system working on the computing system may carry out part or all of the actual processing that realizes the operations of the above-described embodiments.

The computer-executable instructions may be written to a memory provided on a function-extension board inserted into the computing device or on a function-extension unit connected to the computing device, and a CPU provided on the function-extension board or unit may carry out part of all of the actual processing that realizes the operations of the above described embodiments.

While the above disclosure describes illustrative embodiments, it is to be understood that the invention is not limited to the above disclosure. To the contrary, the invention covers various modifications and equivalent arrangements within the spirit and scope of the appended claims.

What I claim is:

1. A dining table placed in a food service establishment with a plurality of Personalized Menu Presentation Devices (PMPD) embedded in said table; wherein upon a food service establishment guest waving a Personal Identification Card (PIC) at the dining table the PMPD in closest proximity to the PIC carried by the guest displays a personalized menu of food items available for consumption at the food establishment that meet the nutritional and monetary limits of the guest and wherein the determination of which food items to display to each guest is based on decrypting the encrypted personal identification information stored in the guest's PIC and using the decrypted personal identification information to lookup a personal record containing personal information such as dietary preferences, energy and nutrient budgets, health information, and monetary budget limits.

2. The PMPD disclosed in claim 1 comprising:
Interactive display,
Non-transient memory for storing a personalized menu presentation manager capable of displaying a personalized set of menu items to each of the food establishment guests on the interactive display of the PMPD in immediate proximity to the guest's PIC device,
Non-transient memory for storing a database containing a list of the food items and their nutritional facts available at the food serving establishment and external device interface for detecting the presence of PIC devices in the immediate proximity of the PMPD and establishing communication links with said PIC devices,
Communications unit capable of establishing secure communication links with PIC communications units over personal area and local area networks, and
Processor capable of executing the various functions of the PMPD stored in the PMPD's non-transient memory.

3. The Personal Identification Card (PIC) disclosed in claim 1 comprising:
Non-transient memory for storing the guest's encrypted personal identification information and external device interface software that identifies and communicates with PMPD devices over secure communication links,
Communications unit capable of establishing secure communication links with PMPD devices communications units over personal and local area networks, and
Processor capable of executing the external device interface software.
